(19) United States
(12) Patent Application Publication
(10) Pub. No.: US 2005/0108535 A1
(43) Pub. Date: May 19, 2005

(54) Collusion-robust watermarking

(76) Inventors: Alphons Antonius Maria Lambertus Bruekers, Eindhoven (NL); Antonius Adrianus Cornelis Maria Kalker, Eindhoven (NL); Michiel Van Der Veen, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,706

(22) PCT Filed: Jan. 21, 2003
(86) PCT No.: PCT/IB03/00215

(30) Foreign Application Priority Data
Feb. 19, 2002 (EP) 02075677.1

(51) Int. Cl. H04L 9/00

(52) U.S. Cl. 713/176

(57) ABSTRACT

Watermark embedding is often used to identify multiple copies (Qi) of the same content (Q). Each copy (Qi) is provided with a different private watermark (Wi) which, for example, identifies the player on which that copy may be reproduced. Private watermarks can be hacked. Averaging two or more watermarked copies may cause any of the private watermarks to become undetectable. The watermark embedder (10) in accordance with the invention embeds a global (fixed) watermark (W) in addition to the private watermark (Wi). The global watermark is the same in each copy and therefore remains detectable. Its presence indicates that a private watermark shall be present as well. It can be used in a protocol like: no playback allowed if the global watermark is present and a private watermark is not found.

### FIELD OF THE INVENTION

The present invention relates to a method and apparatus for embedding watermarks in a signal in a manner that prevents watermark information from being tampered with. The invention also relates to a corresponding method and apparatus for detecting watermarks.

### BACKGROUND OF THE INVENTION

Watermarks are perceptually invisible messages typically embedded in the content of information signals of audio and video. Watermarks can support a wide variety of applications such as monitoring and copy control. In the case, of for instance, copy control, malafide users like to destroy the watermarks so as to be able to distribute illegal copies, which cannot be recognized by the watermarks. Therefore, watermarks have to be “robust”. “Robust” is herein understood to mean that the watermark remains detectable after processing while the signal quality is still sufficient.

A watermark may comprise the identity of a purchaser of a particular copy of the audio, video or other program material. In such a case, each copy of the same material contains a different watermark. Many different watermarking methods have been proposed for this purpose. One method is to slightly vary each copy of an original so that each copy is unique. This allow tracing to a specific version of the original, which is of course a great advantage in the case of copy control. However, this kind of watermark can easily be removed by combining several watermarked copies, by means of so-called “collusion”. This will be explained in more detail below.

Each copy has a slightly different watermark, which is not removable per se. Typically, a user who attacks the copy to remove the watermark uses two copies (or more) of the original to make a third copy by averaging or interleaving the two copies. This third version would be an average of the two copies, so that it will have the same content as the original, but without a watermark. This is because the third copy does not contain sufficient information to be clearly tied to either of the respective watermarks.

Prior techniques for protection against collusion attacks are known in the art. International patent application WO 99/39344, for instance, discloses adding redundancy to watermarking codes to obtain similarity in at least a portion of the watermark information in different copies. However, this implies a large penalty on the required length of the watermark data with respect to the actual embedded information. Also collusion attacks that use a sufficiently large amount of copies will still be able to remove the watermark.

Thus, there is a need of watermark embedding for both video and audio signals that prevents removal of watermarks from a copy by combining copies of the same content signal but comprising different watermarks.

### OBJECT AND SUGARY OF THE INVENTION

It is an object of the invention to provide a method of embedding watermarks in a signal, which method prevents removal (to be understood to also mean making detection more difficult) of watermarks from a copy by combining copies of the same content signal but comprising different watermarks.

According to an aspect of the present invention, this is realized in a method of embedding watermarks in multiple copies of an information signal, the method comprising the steps of embedding, in each copy of said information signal, a predetermined unique watermark which is different for each copy, and embedding, in all copies, a further predetermined same global watermark. The global watermark indicates that the unique watermark should also be present. It is achieved with the invention that playback can be prohibited in situations where the global watermark is detected but the unique watermark is not found.

According to another aspect of the invention, the presence of the global watermark is used in a protocol like: no playback allowed if the global watermark is present and no unique watermark is found.

According to another preferred embodiment of the invention, there is further provided a method of detecting watermarks in an information signal, the method comprising the steps of detecting if a predetermined unique watermark is present, detecting if a predetermined global watermark is present, and concluding that the unique watermark should have been present, and acting in accordance therewith if the global watermark is detected and the unique watermark is not detected.

Thus, a principal aspect of the invention is collusion-robust watermarking using an additional fixed watermark along with a unique variable watermark.

The above described aspects and other aspects of the invention are apparent from and will be elucidated with reference to the embodiments described hereinafter.

### BRIEF-DESCRIPTION OF THE DRAWINGS

FIG. 1 is a block diagram showing a watermark embedder according to a preferred embodiment of the invention.

FIG. 2 is a flow chart showing a method of detecting the watermarks according to a preferred embodiment of the invention.

### DETAILED DESCRIPTION OF EMBODIMENTS OF THE INVENTION

The invention will now be described in more detail, starting with a further explanation of the problem with collusion before describing particular embodiments of the invention.

Embedding a watermark in a content signal can be provided by adding a secret sequence, i.e. a watermark W to an original signal X, which may be a video or an audio signal, to obtain a watermarked signal Y in accordance with formula (I):
Y=X+W (I)

Details like global scaling factors etc. are not described in this document, because they are not essential for understanding the invention, but nevertheless they are within the scope of the invention as defined by the claims.

If the original signal X, for example an audio signal such as a music recording, is copied multiple times, each copy having an index i is embedded with a unique watermark Wᵢ to allow, for instance, selective playback control. The expression “copy” is herein understood to mean a version of the signal which is perceptually substantially identical to the original. For example, an MP3 encoded music song and a WMA encoded music song may both be copies of an original piece of music. The watermarked signal Yᵢ for each copy can be presented in a formula (II):
Yᵢ=X+Wᵢ (II)

This means that the watermarked signal Yᵢ can only be played back on player i. However, if a number of N watermarked signals are averaged (the collusion as described in the “background of the invention”), a new averaged signal Z can be presented in a formula (III):

$$Z = X + \frac{1}{N} {\sum }_{i} {W}_{i} \approx X \qquad ( III )$$

As is evident from formula (III), it is possible that none of the unique watermarks Wᵢ can be detected in this situation and, as a consequence, the watermarks are considered not to be present and are therefore “non-robust”. The signal Z can now be played on any player. The original signal X is not changed in the collusion, assuming that all watermarked signals Yᵢ were time-aligned prior to averaging.

The present invention is directed to a method and corresponding apparatus for embedding watermarks in a content signal, such as a video signal, an audio signal, or image signals such as JPEG, GIF, TIF or the like, which method and apparatus prevent removing the watermarks by combining two or more copies of the same content signal which also comprise different watermarks by introducing a global watermark W to the original signal, which can be represented by a formula (IV):
Yi=X+W+Wᵢ (IV)
If now a number of N signals are averaged, the new averaged signal Z becomes:

$$Z = X + W + \frac{1}{N} {\sum }_{i} {W}_{i} \approx X + W \qquad ( V )$$

Also in this case, the unique watermarks Wᵢ will probably be non-detectable but the global watermark W still is. The presence of the global watermark W can now be used in a protocol like: no play-back allowed if the global watermark W is present and no private watermark Wᵢ is found.

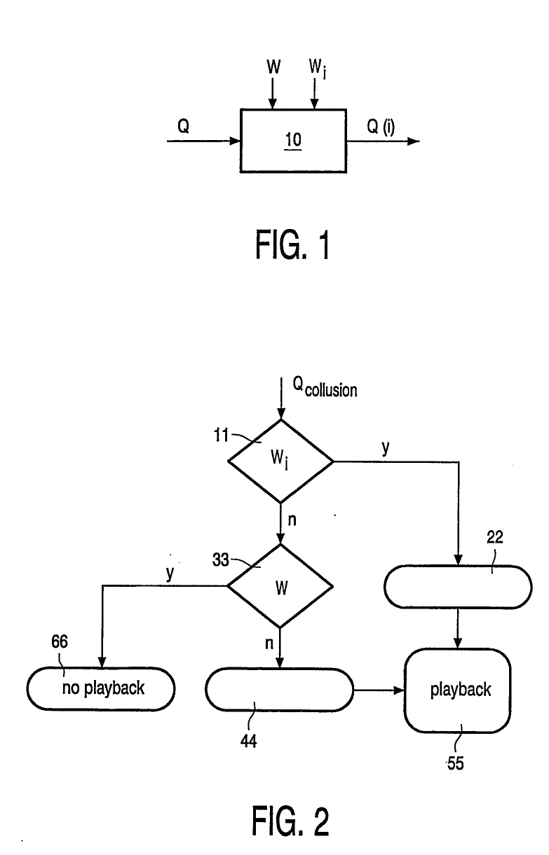

As shown in FIG. 1, according to a preferred embodiment of the invention, a watermark embedder 10 receives a content signal Q (in this case an audio signal) and embeds in the content signal Q a private watermark Wᵢ and a global watermark W for each outgoing copy Qᵢ of the original signal Q.

The resultant watermarked signal Qᵢ is then transmitted to different receivers (not shown). The receivers, which also comprise some users that try to decode the signals Qᵢ and remove the watermarks, will then be able to remove the unique watermark Wᵢ by co-operating with another user, but cannot remove the global watermark W.

In some situations, where the unique watermark Wᵢ was not considered to be present, the global watermark was searched and found, indicating that the first watermark should have been present. This is illustrated in FIG. 2. Such a situation occur, may for instance, when a detector in a multimedia-player controls the playback.

FIG. 2 shows a method according to a preferred embodiment of the invention, wherein a unique watermark Wᵢ and a global watermark W are detected in an incoming signal Q_{collusion}. In this example, it is assumed that two watermarks, a unique watermark Wᵢ and a global W were embedded in each signal outgoing from the watermark embedder shown in FIG. 1, of which at least two users, who have each received a unique copy Yᵢ of the original signal X, have co-operated to delete the unique watermarks Wᵢ by combining the copies Yᵢ obtained from the embedder. The resulting signal Q_{collusion} is searched for detection of the unique watermark Wᵢ in a first step 11. If the unique watermark Wᵢ is found, it is labeled as being present in a second step 22.

If, on the contrary, in the first step 11, the unique watermark Wᵢ is not found, a third step 33 is performed for detection of the global watermark W. If this global watermark W is detected and the unique watermark Wᵢ was not detected, playback is stopped (step 66).

If the global watermark W is not detected in the third step 33, the copy is considered to be free from watermarks (step 44), and playback is allowed in a fifth step 55. Play back is also allowed if, in the second step 22, the unique watermark Wᵢ was found and the copy was intended for this user, i.e. if the signal coming in was the unique signal Qᵢ and not the collusion signal Q_{collusion}.

The concept of unique and global watermarks allows signals to be classified in a hierarchical data structure. For example, the global and unique watermarks may represent Hours and Minutes, respectively, of a time stamp. If the content provider traces an illegal version (in the sense that the unique watermark has been affected by averaging two or more copies), he will be able to conclude that the contents has been tampered with by parties that obtained copies having a time stamp, for example, in the range 10.00-10.59.

Specific watermarking processes employed for embedding or detecting watermarks are not part of the invention, but any conventional watermarking processes could be employed without departing from the invention. Preferably, the global watermark W is robust against all kinds of malicious attacks. The signal to be protected may be an image, a video sequence, or audio. The particular type to be protected is not relevant to the invention. As used in the following claims, the verbs “comprise” or “include” or their conjunctions mean “including, but not necessarily limited to”.

The invention can be summarized as follows. Watermark embedding is often used to identify multiple copies (Qᵢ) of the same content (Q). Each copy (Qᵢ) is provided with a different private watermark (Wᵢ) which, for example, identifies the player on which that copy may be reproduced. Private watermarks can be hacked. Averaging two or more watermarked copies may cause any of the private watermarks to become undetectable. The watermark embedder (10) in accordance with the invention embeds a global (fixed) watermark (W) in addition to the private watermark (Wᵢ). The global watermark is the same in each copy and therefore remains detectable. Its presence indicates that a private watermark shall be present as well. It can be used in a protocol like: no playback allowed if the global watermark is present and a private watermark is not found.

1. A method of embedding watermarks in multiple copies of an information signal (Q), the method comprising the steps of embedding, in each copy (Qᵢ) of said information signal (Q), a predetermined unique watermark (Wᵢ) which is different for each copy (Qᵢ); and embedding, in all copies (Qᵢ), a further predetermined same global watermark (W).

2. A method as claimed in claim 1, wherein said global watermark (W) is embedded in a copy (Qᵢ) of the information signal to indicate that a unique watermark (Wᵢ) has been embedded in said copy.

3. A method of detecting watermarks in an information signal, the method comprising the steps of:
detecting if a predetermined unique watermark (Wᵢ) is present,
detecting if a predetermined global watermark (W) is present,
concluding that the unique watermark (Wᵢ) should have been present, and acting in accordance therewith if the global watermark (W) is detected and the unique watermark (Wᵢ) is not detected.

4. A method as claimed in claim 3, wherein said acting comprises preventing said information signal from being further processed.

5. A method as claimed in claim 4, wherein said further processing comprises play back of the information signal.

6. An apparatus for embedding watermarks in multiple copies of an information signal (Q), the apparatus comprising means for embedding, in each copy (Qᵢ) of said information signal (Q), a predetermined unique watermark (Wᵢ) which is different for each copy (Qᵢ); and embedding, in all copies (Qᵢ), a further predetermined same global watermark (W).

7. An apparatus as claimed in claim 6, wherein said global watermark (W) indicates that a unique watermark (Wᵢ) has been embedded in said copy.

8. An apparatus for detecting watermarks in an information signal, the apparatus comprising:
means for detecting if a predetermined unique watermark (Wᵢ) is present,
means for detecting if a predetermined global watermark (W) is present,
signaling means for concluding that the unique watermark (Wᵢ) should have been present, and for controlling further processing of the information signal in accordance therewith if the global watermark (W) is detected and the unique watermark (Wᵢ) is not detected.

9. An apparatus as claimed in claim 8, wherein said controlling comprises preventing said information signal from being further processed.

10. An apparatus as claimed in claim 9, wherein said further processing comprises play back of the information signal.

11. An information signal with embedded watermarks, said watermarks including a first watermark (Wᵢ) being unique with respect to multiple copies of said information signal, and a further predetermined second global watermark W indicating that the unique watermark (Wᵢ) has been embedded in said information signal, said global watermark (W) being the same for all of said multiple copies of the information signal.

12. A record carrier having recorded thereon an information signal with embedded watermarks, said watermarks including a first watermark (Wᵢ) being unique with respect to multiple copies of said information signal, and a further predetermined second global watermark W indicating that the unique watermark (Wᵢ) has been embedded in said information signal, said global watermark (W) being the same for all of said multiple copies of the information signal.
